(19) United States
(12) Patent Application Publication
(10) Pub. No.: US 2026/0265275 A1
(43) Pub. Date: Sep. 10, 2026

(54) PHOSPHORIC ACID ESTER COMPOSITIONS FOR FLAME-RETARDANT SOFT PVC WITH HIGH COLOUR STABILITY

(71) Applicant: LANXESS Deutschland GmbH, Cologne (DE)

(72) Inventors: Lukas Omann, Cologne (DE); Otto Mauerer, Leichlingen (DE); Jan-Gerd Hansel, Bergisch Gladbach (DE)

(73) Assignee: LANXESS Deutschland GmbH, Cologne (DE)

(21) Appl. No.: 19/162,603

(22) PCT Filed: Mar. 5, 2024
(86) PCT No.: PCT/EP2024/055659

§ 371 Date: Sep. 5, 2025

(30) Foreign Application Priority Data
Mar. 15, 2023 (EP) 23162061.8

(51) Int. Cl. C07F 9/09; C08F 14/06; C08K 5/521

(52) U.S. Cl. CPC C07F 9/09; C08F 14/06; C08K 5/521

(57) ABSTRACT

Mixtures comprising at least two substances of the general formula (I)

$${( RO )}_{m} {( PhO )}_{3 - m} P = O \qquad ( I )$$

with m=1, 2 or 3, in which R corresponds to the radical

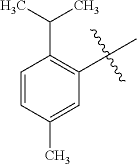 [SMILES: *c1cc(C)ccc1C(C)C]

and Ph corresponds to the phenyl radical, exhibit a unique combination of high colour stability, high flame retardancy and plasticizing effect, which makes them suitable for use as flame retardants in PVC compounds, as hydraulic fluid, as lubricant additive or as additive for paints, adhesives, sealants or coatings.

Phosphoric acid esters can be used in various technical applications, for example as lubricants (cf. U.S. Pat. No. 10,414,964 B2), hydraulic fluids (cf. U.S. Pat. No. 6,703,355 B2), plasticizers (cf. DE 1 768 076) or as flame retardants (cf. U.S. Pat. No. 8,129,457 B2).

The flame-retardant effect of phosphoric acid esters has already been demonstrated in various plastics, for example in PVC (cf. GB 2 302 543 A), in polyolefins (cf. U.S. Pat. No. 11,008,440 B2), in cellulose esters (U.S. Pat. No. 9,000,148 B2), in polyurethanes (cf. U.S. Pat. No. 8,129,457 B2) or in styrene polymers (cf. U.S. Pat. No. 8,026,303 B2).

The prior art describes various types of phosphoric acid esters and the use thereof as flame retardants. For example, use is made of phosphoric acid aryl esters, which are composed of phenol, cresol, tert-butylated phenol, isopropylated phenol or mixtures thereof.

In addition to phosphoric acid triaryl esters, mixed phosphoric acid alkyl aryl esters are also known to those skilled in the art. These are used for example as flame retardants if increased colour stability or heat stability is required (cf. U.S. Pat. No. 5,087,521). This is required, inter alia, for plastics for outdoors, in particular for coatings, for cables, for tarpaulins, awnings or tents, so that the material does not yellow under the action of heat. However, the increased colour stability comes at the price of a lower flame-retardant effect in comparison with triaryl phosphates. U.S. Pat. No. 5,087,521 therefore uses mixtures of diaryl alkyl phosphates and triaryl phosphates. Even though this defect can be mitigated in accordance with U.S. Pat. No. 5,087,521 by the use of mixtures of diaryl alkyl phosphates and triaryl phosphates, the poor flame-retardant effect of phosphoric acid alkyl aryl esters remains a disadvantage. The use of two different flame retardant preparations in accordance with U.S. Pat. No. 5,087,521 also represents considerable additional synthetic complexity.

US 20120004438 A1 discloses a process for preparing mixed alkylated triaryl phosphates, in which the first step involves the reaction of an alkylated phenol (comprising up to 25% of dialkylated phenol) with POCl₃, with the result that a product comprising more than about 75 mol % of monoalkylphenyl dichlorophosphates is obtained. This is then further reacted with further alkyl or aryl alcohols to form the triester (cf. Claim 1). However, the triesters obtained do not exhibit improved colour stabilization in comparison with the flame retardants of the prior art (cf. Table 23), with the interpretation of the results being made even more difficult since it was not specifically specified which of the flame retardants according to the invention were used in Examples TS-06-9D to TS-06-9F.

Similarly, mixtures of cyclic aryl phosphates with halogen-containing compounds are used in EP 0401366 A4 for the production of colour-stable, flame-retardant PVC materials. However, the use of halogen-containing flame retardants is often problematic from a regulatory perspective.

The phosphoric acid triaryl ester compositions described in the prior art generally exhibit a high flame-retardant effect in PVC. However, the soft-PVC materials produced therewith have low thermal stability. A further disadvantage of many phosphoric acid triaryl ester compositions from the prior art is their content of triphenyl phosphate. The hazardous substance properties thereof have led to the demand for ever lower contents of this substance in consumer applications.

For the production of soft PVC with increased thermal stability, complex formulations comprising a plasticizer, a flame retardant, a stabilizer and optionally further additives are also known to those skilled in the art. For example, WO 2022/121330 A1 describes the production of flame-retardant soft PVC, in which use is made of a mixture of trioctyl trimellitate (plasticizer), antimony trioxide (flame retardant), a calcium-zinc stabilizer and calcium carbonate (filler). However, the high number of additives required leads to considerable additional technical complexity. In addition, antimony trioxide has an adverse effect on the transparency of the PVC compound, which is undesirable for some demanding applications.

The object of the present invention was therefore to provide a flame retardant preparation which, in addition to a sufficient flame-retardant effect, has a plasticizing effect for plastics, in particular for PVC moulding compounds, and additionally a high colour stability. Preferably, this flame retardant should be in liquid form at room temperature, and should be obtainable by a less complex process and with a low content of triphenyl phosphate.

Said object is achieved by mixtures comprising at least two substances of the general formula (I)

$${( RO )}_{m} {( PhO )}_{3 - m} P = O \qquad ( I )$$

with m=1, 2 or 3, in which R corresponds to the radical

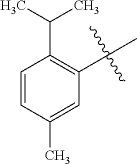 [SMILES: *c1cc(C)ccc1C(C)C]

and Ph corresponds to the phenyl radical.

In a preferred embodiment of the invention, the mixture according to the invention comprises (RO)₃P═O, (RO)₂(PhO)P═O, (RO)(PhO)₂P═O and (PhO)₃P═O (triphenyl phosphate, “TPP”), and optionally secondary components, such as thymol, phenol, catalyst constituents, or byproducts.

The mixtures according to the invention preferably comprise 50% by weight or more, particularly preferably 70% by weight or more, very particularly preferably 80% by weight or more and most preferably 90% by weight or more of substances of the general formula (I)

$${( RO )}_{m} {( PhO )}_{3 - m} P = O , \qquad ( I )$$

where R, Ph and m have the definitions given above.

In a preferred embodiment, the mixtures according to the invention comprise
(i) 5% to 90% by weight of (RO)₂(PhO)P═O, and
(ii) 5% to 90% by weight of (RO)(PhO) 2P═O,
   in each case based on the total amount of compounds of formula (I) with m=0, 1, 2 or 3, where R and Ph have the definitions given above.

A further preferred embodiment is mixtures comprising:

$$\begin{matrix}{( RO )}_{3} P = O & 0 \% to 30 \% by weight \\ {( RO )}_{2} ( PhO ) P = O & 5 \% to 90 \% by weight \\ ( RO ) {( PhO )}_{2} P = O & 5 \% to 90 \% by weight \\ {( PhO )}_{3} P = O {(}^{″} {TPP}^{″} ) & 0 \% to 30 \% by weight\end{matrix}$$

in each case based on the total weight of the compounds of formula (I) with m=0, 1, 2 or 3, preferably in each case based on the total weight of the mixture, where R and Ph have the definitions given above.

Preferably, the mixtures according to the invention comprise less than 1% by weight, particularly preferably less than 0.5% by weight, further preferably less than 0.2% by weight, very particularly preferably less than 0.5% by weight and most preferably not more than 0.1% by weight of triphenyl phosphate.

Preferably, the mixtures according to the invention are present as a liquid at 23° C., since such a state facilitates or even enables the use as flame retardants or in lubricants or hydraulic fluids. Preferably, the mixtures according to the invention have a dynamic viscosity of 20 to 5000 mPa-s, particularly preferably of 50 to 2000 mPa-s (in each case at 23° C.).

Preferably, the mixtures according to the invention have an acid value of less than 5 mg KOH/g, preferably less than 1 mg KOH/g, particularly preferably less than 0.3 mg KOH/g, very preferably less than 0.1 mg KOH/g.

It has surprisingly been found that PVC moulding compounds comprising the mixture according to the invention have high colour stability and high flame retardancy. The mixtures according to the invention can be prepared unexpectedly easily in a novel process. A preferred embodiment of the process enables the preparation in a form in which the mixture comprises no or only very little triphenyl phosphate.

The invention further provides a process for preparing the mixtures according to the invention, comprising the steps of
a) provision of a mixture comprising phosphorus oxychloride and thymol,
b) reaction of at least part of the mixture from a) at temperatures between 80° C. and 300° C. with removal of hydrogen chloride,
c) addition of phenol to the mixture obtained from b) and further reaction between 100° C. and 300° C. with elimination of hydrogen chloride.

In an alternative embodiment, at least part of the phosphorus oxychloride is metered in only in step b). It is also possible for at least part of the thymol to be metered in only in step b).

A catalyst may optionally be added to the mixture provided in step a) or during step b). Suitable catalysts are NaCl, KCl, LiCl, MgCl₂, MgO, CaCl₂, AlCl₃, FeCl₃, ZnCl₂, TiCl₄, SbCl₄ and others. Optionally, one or more catalysts may also be added before or during step c).

The reaction according to step b) is usually performed in the range from 80° C. to 300° C., preferably in the range from 100° C. to 250° C., particularly preferably in the range from 100° C. to 200° C.

Optionally, a distillative removal of (unreacted) reactants from step a) and/or formed byproducts may be performed between step b) and step c). The distillation may be carried out as a batch process or as a continuous process. The temperature of the distillation is preferably in the range from 80° C. to 250° C. Particularly preferably, the distillation is carried out at the reaction temperature of step b) or at a temperature between 80° C. and the reaction temperature of step b). The distillation is performed in a pressure range from 0.01 mbar to 1013 mbar, preferably in the range from 0.01 mbar to 100 mbar, very particularly preferably in the range from 0.01 mbar to 50 mbar.

The reaction according to step c) is usually performed in the range from 100° C. to 300° C., preferably in the range from 100° C. to 250° C., particularly preferably in the range from 120° C. to 250° C.

In an alternative embodiment, at least part of the phenol is metered in only during the reaction in step c). It is also possible for at least part of the reaction mixture obtained from step b) (either directly or after distillative removal of the reactants from step a) and/or formed byproducts in step b)) to be metered in during the reaction in step c).

Optionally, a distillative removal of (unreacted) reactants and/or formed byproducts from steps b) and/or step c) may be performed after step c). The distillation may be carried out as a batch process or as a continuous process. The temperature of the distillation is preferably in the range from 80° C. to 250° C. The distillation is performed in a pressure range from 0.01 mbar to 1013 mbar, preferably in the range from 0.01 mbar to 100 mbar, very particularly preferably in the range from 0.01 mbar to 50 mbar.

Depending on the application, the mixtures according to the invention may also comprise further auxiliaries. Examples of suitable auxiliaries are plasticizers, plasticizing polymers, polymer modifiers, stabilizers (for example thermal stabilizers, light stabilizers, antioxidants), co-stabilizers (for example acid scavengers, free-radical scavengers), internal and external lubricants, viscosity regulators, fillers, colour pigments, dyes, flame retardants, flame retardant synergists, blowing agents and further functional additives such as antistatic agents, nucleating agents, UV protection agents or biocides (see for example R. D. Maier, M. Schiller, Handbuch Kunststoff-Additive [Plastics Additives Handbook], 4th edition, Munich, Carl Hanser Verlag, 2016, p. 513 ff.).

The mixtures according to the invention are suitable as flame retardants. The present invention thus further provides for the use of the mixtures according to the invention as flame retardants.

The mixtures according to the invention can be used as flame retardants in all applications for flame retardants that are known to those skilled in the art. Preferably, the mixtures according to the invention are used as flame retardants for
synthetic polymers, such as polyolefins, polyvinyl chloride, polycarbonates, styrene-based (co)polymers, polyamides, polyesters, polyurethanes, elastomers such as NBR, CR, SBR, or EPDM and thermosets such as epoxy resins, unsaturated polyester resins and phenol formaldehyde resins,
materials of plant origin, such as wood, wood-plastic composites, paper and cardboard, and
materials of animal origin, such as leather.

Particular preference is given to using the mixtures according to the invention as flame retardants for polyvinyl chloride (PVC), for example in PVC moulding compounds, i.e. in compositions comprising PVC which are in the form of granules, a powder, a paste or a plastisol.

The invention therefore also provides compositions preferably in the form of granules, a powder, a paste or a plastisol, comprising a mixture according to the invention and polyvinyl chloride (PVC). These PVC moulding compounds according to the invention are preferably soft PVC. The PVC moulding compounds according to the invention can be produced by mixing and compounding PVC with the mixtures according to the invention and optionally further auxiliaries, e.g. stabilizers, in a known manner (see for example G. Becker, D. Braun, Kunststoff-Handbuch, Polyvinylchlorid [Plastics Handbook, Polyvinyl Chloride], Vol. 2/2, Munich, Vienna, Card Hanser Verlag, 1986, p. 829 ff.) or dispersing it to form a ready-to-process plastisol or organosol.

The PVC moulding compound according to the invention preferably comprises 5 to 150 parts by weight, particularly preferably 30 to 70 parts by weight of phosphoric acid esters of formula (I) based on 100 parts by weight of PVC. In a preferred embodiment, the PVC moulding compound according to the invention comprises 5 to 150 parts by weight, particularly preferably 30 to 70 parts by weight of phosphoric acid esters of formula (I) based on 100 parts by weight of PVC.

The PVC moulding compound according to the invention can be used in coatings, films, cables, pipelines, hoses, seals, conveyor belts, roofing membranes, adhesive tape films, tarpaulins, awnings and tents.

The invention further provides for the use of the mixtures according to the invention in hydraulic fluids or for the production of hydraulic fluids. Preferably, the mixtures according to the invention are used in flame-retardant hydraulic fluids.

The invention further provides for the use of the mixtures according to the invention as lubricant additive. Preferably, the mixtures according to the invention are used in flame-retardant lubricants.

The invention further provides for the use of the mixtures according to the invention as additive for paints, adhesives, sealants and coatings.

The invention further provides for the use of the mixtures according to the invention as heat transfer medium or in preparations that are used as heat transfer medium. Preferably, the mixtures according to the invention are used as heat transfer medium or in heat transfer medium preparations in the immersion cooling of electrical components. In addition to the mixtures according to the invention, the heat transfer medium preparations for example comprise further trialkyl phosphates, triaryl phosphates, mineral oils, polyalphaolefins, esters, antioxidants, metal deactivators, flow additives, corrosion inhibitors, foam inhibitors, demulsifiers and/or pour point depressants.

### EXAMPLES

### Synthesis Examples

### Synthesis Example 1

Phosphorus oxychloride (200 parts by weight), thymol (197 parts by weight) and magnesium chloride (0.1 parts by weight) were initially charged into a reactor with stirrer, internal thermometer, nitrogen inlet and reflux condenser. The reaction mixture was heated to 120° C. with stirring and kept at this temperature until hardly any gas formation was observed. The pressure in the apparatus was reduced stepwise from atmospheric pressure to 10 mbar and kept under final conditions for 1 h. After addition of phenol (307 parts by weight), the temperature of the reaction mixture was increased stepwise to a final temperature of 160° C. and kept at this temperature until conversion was complete. Excess phenol was removed at a final temperature of 160° C. and a pressure of 10 mbar. The product mixture was isolated as a viscous liquid (110 mPa-s at 23° C.). The acid value was <0.1 mg KOH/g. The product mixture comprised 0.6% by weight of (thymylO)₃P═O, 12.7% by weight of (thymylO)₂(PhO)P═O, 86.3% by weight of (thymylO)-(PhO)₂P═O and 0.4% by weight of (PhO)₃P═0 (“TPP”).

### Synthesis Example 2

Phosphorus oxychloride (200 parts by weight), thymol (295 parts by weight) and magnesium chloride (0.1 parts by weight) were initially charged into a reactor with stirrer, internal thermometer, nitrogen inlet and reflux condenser. The reaction mixture was heated stepwise to 160° C. with stirring and kept at this temperature until hardly any gas formation was observed. After addition of phenol (307 parts by weight), the temperature of the reaction mixture was increased stepwise to a final temperature of 190° C. and kept at this temperature until conversion was complete. Excess phenol was removed at a final temperature of 190° C. and a pressure of 10 mbar. The product mixture was isolated as a viscous liquid (210 mPa-s at 23° C.). The acid value was <0.1 mg KOH/g. The product mixture comprised 2.4% by weight of (thymylO)₃P═O, 56.0% by weight of (thymylO)₂(PhO)P═O, 41.4% by weight of (thymylO)-(PhO)₂P═O and 0.2% by weight of (PhO)₃P═O (“TPP”).

### Synthesis Example 3

Phosphorus oxychloride (200 parts by weight), thymol (394 parts by weight) and magnesium chloride (0.1 parts by weight) were initially charged into a reactor with stirrer, internal thermometer, nitrogen inlet and reflux condenser. The reaction mixture was heated stepwise to 160° C. with stirring and kept at this temperature until hardly any gas formation was observed. After addition of phenol (186 parts by weight), the temperature of the reaction mixture was increased stepwise to a final temperature of 190° C. and kept at this temperature until conversion was complete. Excess phenol was removed at a final temperature of 190° C. and a pressure of 10 mbar. The product mixture was isolated as a viscous liquid (390 mPa-s at 23° C.). The acid value was <0.1 mg KOH/g. The product mixture comprised 8.6% by weight of (thymylO)₃P═O, 81.1% by weight of (thymylO)₂(PhO)P═O, 10.2% by weight of (thymylO-(PhO)₂P═O and <0.1% by weight of (PhO)₃P═O (“TPP”).

The use amounts for Synthesis Examples S1 to S3 are compiled in Table 1.

TABLE 1
Use amounts and analytical data for Synthesis Examples S1 to S3.

| | | Example | | |
|---|---|---|---|---|
| | | S1 | S2 | S3 |
| Weights | Phosphorus oxychloride | 200 | 200 | 200 |
| [parts by | Thymol | 197 | 295 | 394 |
| weight] | Phenol | 307 | 307 | 186 |
| Composition | (ThymylO)₃PO | 0.6 | 2.4 | 8.6 |
| [% by | (ThymylO)₂(PhO)PO | 12.7 | 56.0 | 81.1 |
| weight] | (ThymylO)(PhO)₂PO | 86.3 | 41.4 | 10.2 |
| | (PhO)₃PO (“TPP”) | 0.4 | 0.2 | <0.1 |

### Determination of the Composition of the Phosphoric Acid Ester Composition

Quantitative GC-FID analysis was carried out using an Agilent 7890A GC instrument equipped with a CB-Sil 5 CB quartz capillary column (length: 30 m, diameter: 0.32 mm, film thickness: 3.00 μm). The carrier gas used was hydrogen. The sample (dissolved in acetone) was injected in split mode (86:1) at a temperature of 300° C. The following temperature program was set: 60° C. start temperature, heating rate 10° C./min to a temperature of 150° C., then at a heating rate of 25° C./min to 280° C., hold time: 10 min, then at a heating rate of 25° C./min to a final temperature of 320° C./min, hold time: 10 min. The evaluation was performed by integration of the corresponding baseline-separated signal and conversion of the peak areas into a content after prior calibration.

### Determination of the Viscosity of the Phosphoric Acid Ester Composition

The dynamic viscosity of phosphoric acid esters was measured using an Anton Paar MCR 102 shear rheometer at the specified temperature with a shear rate of 200 s⁻¹ in accordance with DIN 53018.

### Determination of the Acid Value of the Phosphoric Acid Ester Composition

The acid value of the samples was determined in accordance with DIN EN ISO 2114 (Method B, colorimetric titration with phenolphthalein). To this end, the sample (10 g) was weighed, dissolved in acetone (200 ml) and water (50 ml) and admixed with 2-3 drops of a phenolphthalein solution (0.1% by weight in ethanol/water (v/v=4/1)). Sodium hydroxide solution (0.1 mol/l) was titrated from a burette until the colour change from colourless to pink remained for at least 10 seconds with stirring. A blank value was measured in the same way but without a sample.

### Comparative Specimens of Known Phosphoric Acid Ester Compositions

Table 2 lists known phosphoric acid ester compositions that were used as comparative specimens for the production of soft PVC. All comparative specimens are products from Lanxess Deutschland GmbH.

TABLE 2
Comparative specimens used.

| Comparative | Alcohol/phenol | State at |
|---|---|---|
| specimens | component | 23° C. |
| Disflamoll ® DPK | cresol/phenol | liquid |
| Disflamoll ® TKP | cresol | liquid |
| Disflamoll ® 51092 | t-butylphenol/phenol | liquid |
| Disflamoll ® DPO | phenol/2-ethylhexanol | liquid |
| Reofos ® 65 | isopropylphenol/phenol | liquid |
| Reofos ® 50 | isopropylphenol/phenol | liquid |

### Production of Soft PVC

The soft-PVC moulding compounds used for the testing were produced on a laboratory rolling mill. After the mixture of all formulation constituents (see Table 3) has been added, it is left on the roller until a sheet has formed. From the point in time at which the sheet forms, the compounds were compounded for a further 10 minutes on the rolling mill and finally removed as a rolled sheet. The rolling temperature was 165° C.

The test specimens for determining the LOI were produced from the rolled sheets using a press. The pressing temperature was 170° C.; the pressing duration was 4 minutes for preheating at low pressure (<10 bar) and 2 minutes at high pressure (>100 bar). Test specimens with dimensions of 90×13×4 mm were sawn from the 4 mm-thick pressed plates.

The test specimens for determining the hardness of the compounds (50×40×6 mm) are pressed for longer at the same temperature due to the large thickness of 6 mm. The pressing duration was 7 minutes for preheating at low pressure and 3 minutes for compression moulding at high pressure.

The test specimens for testing the colour stability were cut from a thin (<1 mm) rolled sheet, which was removed from the rolling mill after a rolling time of 10 minutes.

TABLE 3
Formulation constituents for the production of soft PVC.

| | | | Amount |
|---|---|---|---|
| | | | (parts by |
| Component | Function | Description | weight) |
| A | PVC | Vinnol S4170 | 100 |
| B | Co-stabilizer | Drapex 39 | 2.5 |
| C | PVC stabilizer | Barostab UBZ 780 RF | 2.5 |
| D | Flame retardants | As shown in Table 4 | 55 |

PVC specimens were produced according to this procedure.

### Determination of Flame Retardancy and Plasticizing Effect

The limiting oxygen index (=LOI) was used for the assessment of flame retardancy. The LOI is a measure of the burning behaviour of plastics and other materials. The LOI is the minimum oxygen concentration of a nitrogen/oxygen mixture under which the combustion of a test specimen under standardized conditions can just take place. The test was carried out in accordance with ISO 4589-2. For practical applicability, a value of at least 30 should be achieved during the test.

The plasticizing effect of the phosphoric acid esters was determined using a Shore A hardness measurement of the phosphoric acid ester-containing soft-PVC compounds. The measurement principle is based on the penetration depth of a metal test pin into the material sample for 15s with a force of 12.5 N. The Shore A hardness was determined for test specimens with dimensions of 50×40×6 mm. The Shore hardness measurement was performed in accordance with DIN ISO 7619-1. A Shore A hardness of less than 95 is to be considered as an indicator of a plasticizing effect.

The results of the measurements are compiled in Table 4.

TABLE 4
Determination of the flame retardancy
of the PVC specimens produced retardant

| | Flame retardant | | Shore A |
|---|---|---|---|
| Example | (Component D) | LOI >30 | hardness <95 |
| V1 | Disflamoll DPK | + | + |
| V2 | Disflamoll TKP | + | + |
| V3 | Disflamoll 51092 | + | + |
| V4 | Disflamoll DPO | − | + |
| V5 | Reofos 65 | + | + |
| V6 | Reofos 50 | + | + |
| E7 | S1 | + | + |
| E8 | S2 | + | + |
| E9 | S3 | + | + |

The results show that the phosphoric acid ester compositions according to the invention bring about similarly good flame-retardant properties in PVC as the comparative products Disflamoll DPK, Disflamoll TKP, Disflamoll 51092 and Reofos 65. As expected, the LOI of the PVC compound of the phosphoric acid alkyl aryl ester Disflamoll DPO is significantly lower, which is associated with a lower flame-retardant effect. All flame retardants used achieved Shore A hardnesses of less than 95 in the test, i.e. exhibited a plasticizing effect.

### Determination of Colour Stability

All plastics are subjected to an undesirable ageing process, which is reflected in altered mechanical values and a change in colour, usually yellowing. The colour stability of the soft-PVC compounds under thermal stress was tested using a Mathis oven (Mathis Thermotester LTE T). In this case, material samples were stored at 180° C. in a convection oven for 30 minutes. At intervals, material samples were removed from the hot oven area so that material samples exposed to temperature for different durations were obtained. The yellow values (delta E values) were determined using a Minolta Chroma Meter CR 400. The measurement was carried out in accordance with DIN-EN-ISO 10545-16.

TABLE 5
Measured yellow values after storage in the oven at 180° C.

| | | Increase in yellow value after specified time | | | | | |
|---|---|---|---|---|---|---|---|
| Exa- | Flame retardant | 5 | 10 | 15 | 20 | 25 | 30 |
| mple | (Component D) | min | min | min | min | min | min |
| V1 | Disflamoll DPK | 1.20 | 8.35 | 40.68 | 71.38 | 63.91 | 65.21 |
| V2 | Disflamoll TKP | 0.92 | 3.25 | 16.94 | 66.79 | 65.38 | 63.23 |
| V3 | Disflamoll 51092 | 1.00 | 5.57 | 18.46 | 63.49 | 71.09 | 63.28 |
| V4 | Disflamoll DPO | 1.45 | 9.17 | 31.13 | 67.00 | 75.17 | 65.76 |
| V5 | Reofos 65 | 0.35 | 3.75 | 14.89 | 41.86 | 56.33 | 68.88 |
| V6 | Reofos 50 | 0.33 | 3.12 | 15.59 | 39.08 | 58.80 | 60.74 |
| E7 | S1 | 1.72 | 1.58 | 1.49 | 5.68 | 25.62 | 44.74 |
| E8 | S2 | 0.26 | 0.48 | 2.07 | 7.27 | 15.63 | 30.91 |
| E9 | S3 | 0.22 | 0.28 | 1.12 | 4.70 | 9.68 | 23.01 |

The results show that with the PVC compounds comprising the phosphoric acid ester compositions according to the invention S1, S2 and S3, the increase in the yellow value (i.e. the discolouration) occurs significantly later than with the compounds comprising the comparative products.

1. A mixture comprising at least two substances of general formula (I)
$${( RO )}_{m} {( PhO )}_{3 - m} P = O , \qquad ( I )$$
with m=1, 2 or 3, in which R corresponds to a radical 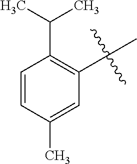 [SMILES: *c1cc(C)ccc1C(C)C]
and Ph corresponds to a phenyl radical.

2. The mixture according to claim 1, comprising
(i) 5% to 90% by weight of (RO)₂(PhO)P═O; and
(ii) 5% to 90% by weight of (RO)(PhO)₂P═O,
where R and Ph have the definitions given in claim 1.

3. The mixture according to claim 1 comprising less than 1% by weight, of triphenyl phosphate.

4. The mixture according to claim 1, wherein the mixture is present as a liquid at 23° C. and 1013 mbar.

5. A process for preparing the mixture according to claim 1 comprising the steps of:
(a) providing a mixture comprising at least:
phosphorus oxychloride and
thymol;
(b) reacting at least part of the mixture from a) at temperatures between 80° C. and 300° C. with removal of hydrogen chloride; and
(c) adding phenol to the mixture obtained from b) and further reacting between 100° C. and 300° C. with removal of hydrogen chloride.

6. The process according to claim 5, wherein a distillative removal of reactants from step a) and/or of byproducts is performed between step b) and step c).

7. The process according to claim 5, wherein a distillative removal of reactants and/or of byproducts from steps b) and/or c) is performed after step c).

8. A flame retardant comprising the mixture according to claim 1.

9. A moulding compound comprising the mixture according to claim 1 and polyvinyl chloride (PVC).

10. The moulding compound according to claim 9 comprising from 5 to 150 parts by weight of phosphoric acid ester of formula (I) based on 100 parts by weight of PVC.

11. (canceled)

12. A hydraulic fluid comprising the mixture according to claim 1.

13. A lubricant additive comprising the mixture according to claim 1.

14. An additive for paints, adhesives, sealants or coatings comprising the mixture according to claim 1.

15. A heat transfer medium comprising the mixture according to claim 1.
